(19) United States
(12) Patent Application Publication
(10) Pub. No.: US 2004/0251287 A1
(43) Pub. Date: Dec. 16, 2004

(54) Snowboard-mounted storage container

(76) Inventor: Micah Thomas Myers, Cardiff by the Sea, CA (US)

Correspondence Address: Micah Thomas Myers, 1835 Playa Riviera Drive, Cardiff by the Sea, CA, 92007, US

(21) Appl. No.: 10/458,698

(22) Filed: Jun. 11, 2003

(51) Int. Cl. B60R 7/00; B60R 9/00; A45F 4/00; A45C 15/00

(52) U.S. Cl. 224/401; 224/584

(57) ABSTRACT

A small tool and accessory storage device for mounting on a snowboard. The two foot bindings on a snowboard are mounted with separation between that defines an open surface on the top sheet of the snowboard. The device is a container having a shape that permits mounting onto the open surface. The device is mounted to the top sheet by two-sided adhesive material, fasteners, or both. The device also comprises a safety cord for connecting the container to the forward binding to prevent loss during a failure of the primary mounting apparatus.

### BACKGROUND

Snowboarding has become a very popular pastime for all ages, and need to carry parts and tools is easily apparent.

Too often, whether caused by delinquent preventative maintenance, part stress and fatigue, or merely bad luck, snowboard equipment breaks and snowboard riders find themselves stranded on the side of a mountain with a broken or loose snowboard binding. In such situations, without replacement parts and/or tools, riders must often “unstrap,” releasing their feet from the snowboard bindings, and descend the slopes on foot, traversing whatever distance that may lie between them and available help to address their dilemmas. The situation is not only frustrating but can certainly be dangerous, as well.

In other cases, experienced riders often make adjustments to binding settings multiple times during a single day of riding in order to adjusting to new or changing environmental conditions. Many riders equip themselves, carrying tools and spare parts in pants or jacket pockets and in backpacks but by so doing could potentially increase the probability or severity of injury. Falling onto a tool stored in a garment pocket could easily cause additional bruising or exacerbate an injury.

As on bicycles, storage containers may be mounted to a snowboard. While this container will not replace backpacks, hydration packs, and garment pockets, it will augment storage options currently available.

### BRIEF SUMMARY

This invention offers an alternate means for storing a limited amount of snowboard parts, tools, or other small personal affects. A flexible or rigid case is mounted to the top sheet of a snowboard just aft of the forward binding. This invention attaches easily currently using two-sided adhesive material or, at such a time when snowboard manufacturers incorporate into the design of their snowboards a special lug or multiple lugs for the purposes of mounting this invention, it will easily attach by means of a fastener or multiple fasteners.

### BRIEF DESCRIPTION OF DRAWINGS

FIG. 1 shows a view of the invention mounted to a snowboard.

FIG. 2 shows a view of the open flexible container.

FIG. 3 shows a view of the open rigid container.

FIG. 4 shows a view of the forward face and right side of the flexible container with safety cord attached.

FIG. 5 shows a view of the forward face and right side of the rigid container with safety cord attached.

### DETAILED DESCRIPTION

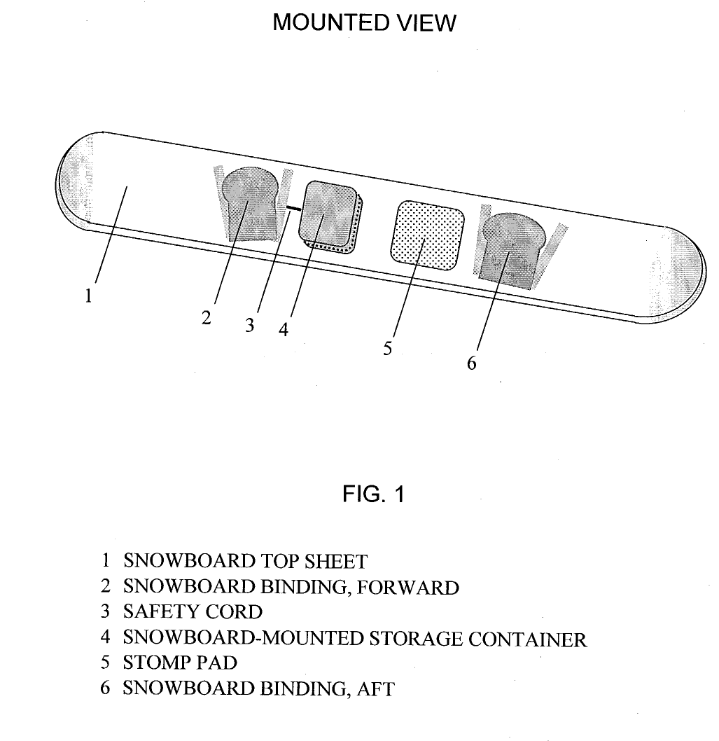

The present invention includes a storage container generally indicated at 4 in FIG. 1. The container 4 is mounted to the snowboard top sheet 1 so as to be disposed just aft of the forward binding 2.

The container 4 is constructed from a flexible material such as canvas, denim, nylon or polyester or a rigid material such as polymer, plastic, or light weight metal and seals such that is able to withstand the outside environment and resist water induction. Since the container is constructed from light-weight materials, the weight of the container 4 is minimized. This can be very important to a snowboarder, as more weight may adversely affect the performance of the snowboard and cause additional shift of the snowboard's center of gravity. Disposed just aft of the forward binding 2, placement approximates the center area of the snowboard and additionally minimizes the impact of center of gravity shift.

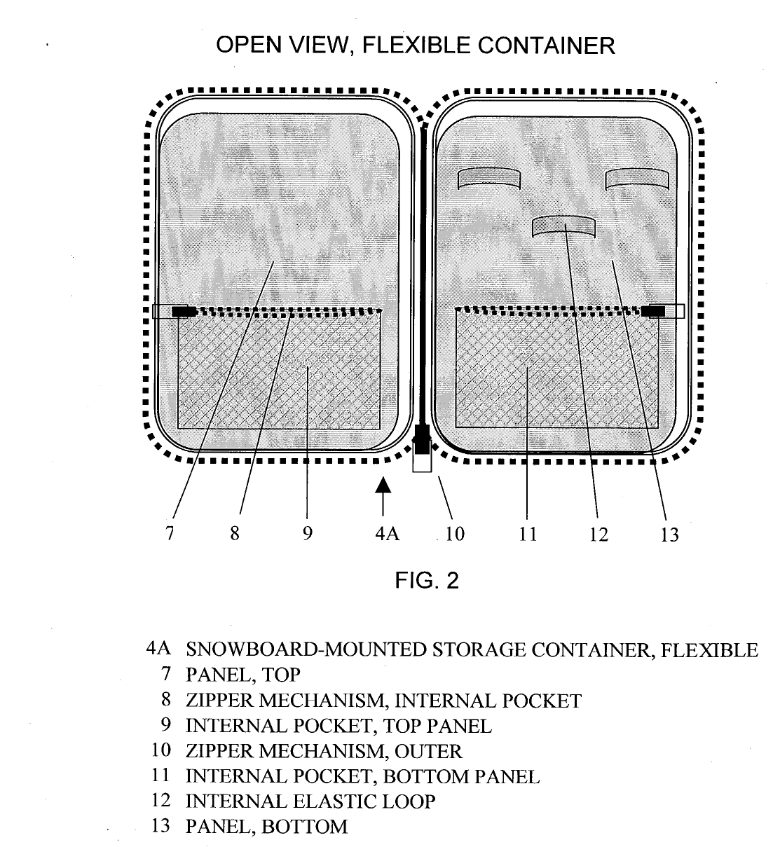

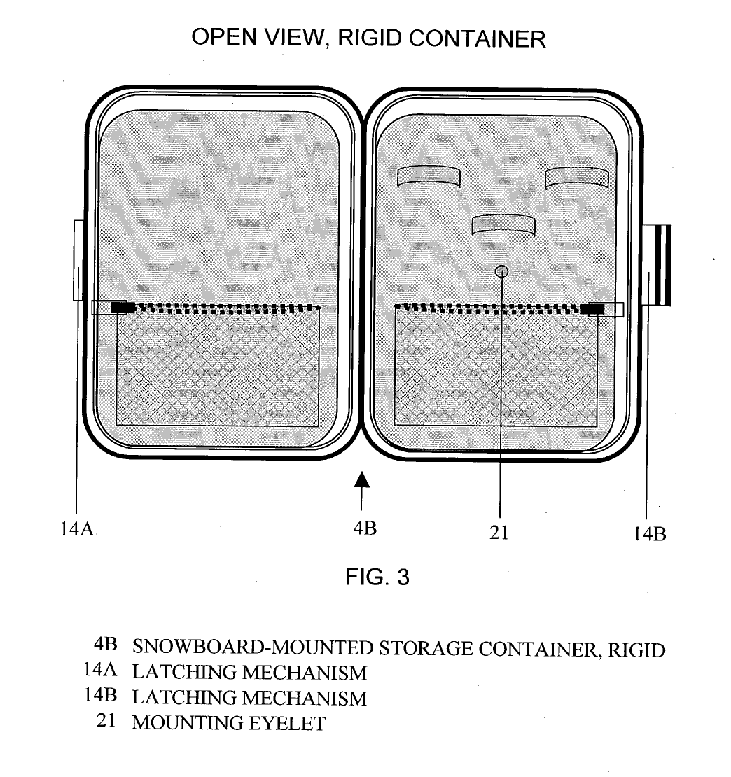

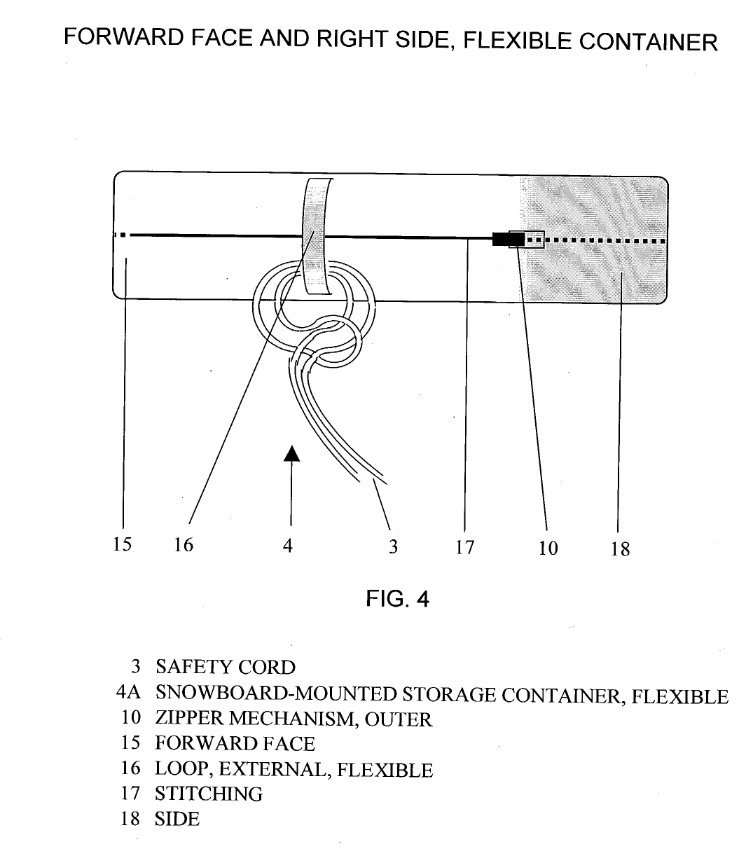

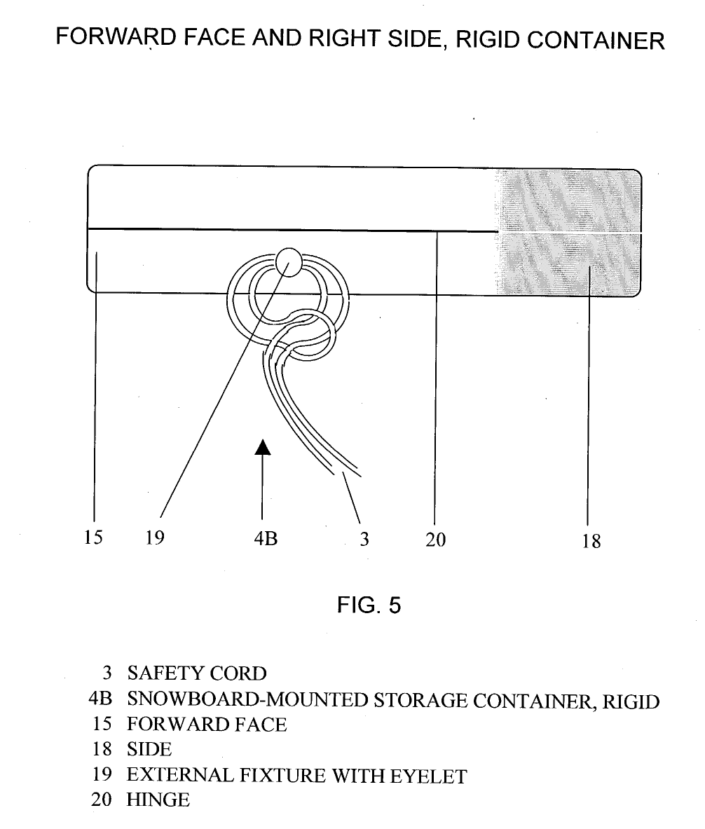

The container 4 includes a top panel 7, FIG. 2, a front face 15, FIG. 4 and FIG. 5, three side walls, a safety cord 3, and a bottom panel 13, FIG. 2. The top panel 7, front face 15, three side walls, and bottom panel 13 define an interior chamber of the container 4. The bottom surface of the bottom panel 13 of the container 4 has a smooth texture that permits mounting to a snowboard top sheet 1 by means of a heavy duty, weather resistant two-sided adhesive material. A fastener placed through the mounting eyelet 21, FIG. 3 may also be used to mount the rigid container 4B to a snowboard if the snowboard is configured with a threaded anchor located and identified for this product.

Pockets 9 and 11, FIG. 2 are affixed internally to the top panel 7 and the bottom panel 13. An elastic retaining loop 12 is affixed to the bottom panel.

The top panel 7 of the flexible container 4A is permanently stitched to the forward face 15. Although stitching is described to construct the flexible container, any method which sealably engages the forward face 15 to the top panel 7 and all the side walls to the bottom panel 13 may be utilized. This may include such methods as heat sealing, stapling, gluing, and ultrasonic welding.

A flexible loop 13, FIG. 4 is permanently stitched to the forward face 15 of the flexible container 4A. A safety cord 3 loops through, or attaches to by a polymer or metal connector, the external flexible loop 13.

In FIG. 5, the top panel 7 of the rigid container 4B is permanently attached to the forward face 15 by means of a hinge 20. The sides of the rigid container 4B are permanently glued to the bottom panel 13. The top panel 7 forms a seal with the remaining sides when secured closed by means of the latching mechanism 14A and 14B, FIG. 3. Although gluing is described to construct the rigid container, any method which sealably engages the sides to the bottom panel 13 may be utilized. This may include such methods as heat sealing, ultrasonic welding, or one piece molding.

An external fixture with eyelet 19, FIG. 5 is permanently attached to the forward face 15 of the rigid container 4B. A safety cord 3 loops through, or attaches to by a polymer or metal connector, the external fixture eyelet 19.

Utilizing a container that mounts onto the top sheet of a snowboard provides an efficient way to store small tools, snowboard binding parts and hardware, and snowboarding accessories, keeping them available while riding a snowboard. The container may be mounted on multiple sizes of snowboards while maximizing the space afforded between the forward and aft bindings.

Although the present invention has been described with reference to preferred embodiments, workers skilled in the art will recognize that changes may be made in form and detail without departing from the spirit and scope of the invention.

What I claim as my invention is:

1. A storage device for mounting on a snowboard comprising a container with:
a safety cord,
a forward face and three side walls,
a bottom panel, wherein the bottom surface of the bottom panel has a smooth texture that permits mounting to a snowboard top sheet by means of a heavy duty, weather resistant two-sided adhesive material,
and a top panel wherein the top panel is permanently attached to the forward face and over hangs and forms a seal over the three remaining side walls.

2. The device of claim 1 wherein the container is a flexible bag constructed of polyester, denim, nylon or canvas.

3. The device of claim 2 wherein the flexible bag is water proof or water resistant.

4. The device of claim 2 wherein the top panel is permanently attached to the forward face by stitching.

5. The device of claim 2 wherein the top panel secures closed and forms a seal over three side walls by means of a zipper mechanism.

6. The device of claim 2 wherein at least one pocket is affixed internally to the bottom panel of the flexible container.

7. The device of claim 2 wherein at least one pocket is affixed internally to the top panel of the flexible container.

8. The device of claim 2 wherein at least one elastic retaining loop is affixed internally to the bottom panel of the flexible container.

9. The device of claim 2 wherein the forward face which is permanently attached to the top panel has a flexible strap disposed near the mid section that is stitched at the top and at the bottom forming an external loop.

10. The device of claim 9 wherein a safety cord threads through the external loop or attaches to the external loop by means of a polymer, plastic, or metal connector.

11. The device of claim 1 wherein the container is a rigid case constructed of a polymer or other plastic, composite, or light weight metal.

12. The device of claim 11 wherein the top panel is permanently attached to the forward face by a hinge.

13. The device of claim 11 wherein the top panel secures closed by means of a latching mechanism.

14. The device of claim 13 wherein the latch is a polymer or other plastic, or metal.

15. The device of claim 11 wherein at least one pocket is affixed internally to the bottom panel of the rigid container.

16. The device of claim 11 wherein at least one pocket is affixed internally to the top panel of the rigid container.

17. The device of claim 11 wherein at least one elastic retaining loop is affixed internally to the bottom panel of the rigid container.

18. The device of claim 11 wherein the forward face permanently attached to the top panel has an external fixture with eyelet attached at the center.

19. The device of claim 18 wherein a safety cord threads through the external fixture eyelet or attaches through the eyelet by means of a polymer, plastic, or metal connector.

20. The device of claim 11 wherein at least one eyelet through the bottom panel exists through which a fastener secures the case to the snowboard.
